(19) United States
(12) Patent Application Publication
(10) Pub. No.: US 2009/0252822 A1
(43) Pub. Date: Oct. 8, 2009

(54) Snow Ball Forming Apparatus

(76) Inventor: Rodney D. Palmer, Harrison, MI (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/060,959

(22) Filed: Apr. 2, 2008

(51) Int. Cl. B28B 3/20

(52) U.S. Cl. 425/318

(57) ABSTRACT

Disclosed is a snow ball forming apparatus for forming snow balls. The snow ball forming apparatus includes a first elongated member, a second elongated member, an attachment means, a first hemispherical cup and a second hemispherical cup. The first and the second elongated members have a top end portion, a bottom end portion, and an inner surface and an outer surface extending between the top end portion and the bottom end portion. The attachment means hingedly couples the first and the second elongated members. Each of the first and the second hemispherical cups are configured at the top end portions of the first and the second elongated members, respectively, and comprise a cavity adapted to receive snow configured therein. The first and the second hemispherical cups may be moved towards each other to form a snow ball from the snow received in the cavity thereof.

### FIELD OF THE INVENTION

The present invention relates generally to snow balls, and more particularly to an apparatus for forming snow balls.

### BACKGROUND OF THE INVENTION

People of all ages enjoy playing snow games by using snow balls. A typical snow ball game, such as a snow ball fight, involves people throwing snow balls at each other. Initially, a person prepares the snow balls by scooping snow with his/her hands and compressing the snow into roughly a fist-sized snow ball. Thereafter, the person throws the snow ball at his/her opponent. Even though the people enjoy playing the snow games by using such snow balls, the above process of forming the snow balls is generally very tedious.

More specifically, while forming the snow balls, the hands of the person may become wet and frozen. Accordingly, the person may need to frequently warm his/her hands. Moreover, the person may be required to use gloves to cover his/her hands. However, the gloves may become wet and may need to be dried more often. Gloves also may hinder or prevent a person from compressing snow sufficiently to form a usable snow ball. In such cases, the person playing a snow ball game may be required to interrupt the game time and again.

Moreover, the snow balls made by the person using his/her hands may not be of a perfect size. For instance, inadvertently the person may form bulky snow balls that may hurt a person on whom the snow ball is thrown. Additionally, the bulky snow balls may be harder for small children to throw.

Accordingly, there is a need for a snow ball forming apparatus that assists a person in forming snow balls without getting his/her hands wet and frozen. Further, there is a need for a snow ball forming apparatus that assists the person to prepare snow balls easily. Also, there is a need for a snow ball forming apparatus that enables the person to prepare snow balls of a suitable size, which can be easily held by the person.

### SUMMARY OF THE INVENTION

In view of the foregoing disadvantages inherent in the prior art, the general purpose of the present invention is to provide a snow ball forming apparatus that is configured to include all advantages of the prior art, and to overcome the drawbacks inherent therein.

Accordingly, an object of the present invention is to provide a snow ball forming apparatus that may assist a person in forming snow balls without getting his/her hands wet and frozen.

Another object of the present invention is to provide a snow ball forming apparatus that assists a person to prepare snow balls easily.

Yet another object of the present invention is to provide a snow ball forming apparatus that assists a person to make snow balls of a suitable size, which can be easily held by the person.

In light of the above objects, in one aspect of the present invention, a snow ball forming apparatus is disclosed. The snow ball forming apparatus includes a first elongated member, a second elongated member, an attachment means, a first hemispherical cup and a second hemispherical cup. The first elongated member has a top end portion, a bottom end portion, and an inner surface and an outer surface extending between the top end portion and the bottom end portion of the first elongated member. The second elongated member has a top end portion, a bottom end portion and an inner surface and an outer surface extending between the top end portion and the bottom end portion of the second elongated member. Moreover, the first hemispherical cup and the second hemispherical cup are configured at the top end portion of the first elongated member and the top end portion of the second elongated member, respectively. Each of the first hemispherical cup and the second hemispherical cup comprise a cavity configured therein. Additionally, the each of the first hemispherical cup and the second hemispherical cup is coated with a rubber material and is adapted to receive snow. Moreover, the attachment means hingedly couples the second elongated member with the first elongated member at a substantially central portion of the first elongated member and the second elongated member. More specifically, the first elongated member and the second elongated member may be hingedly moved about the attachment means for enabling the snow ball forming apparatus to assume at least one of a closed position and an open position.

To assume the closed position of the snow ball forming apparatus, the first hemispherical cup and the second hemispherical cup move towards each other. The snow received in the cavity of the each of the first hemispherical cup and the second hemispherical cup forms a snow ball in the closed position of the snow ball forming apparatus.

In another aspect of the present invention, the first elongated member and the second elongated member of the snow ball forming apparatus have a U-shaped cross-section, which enables a proper alignment between the first and the second elongated member.

In yet another of the present invention, a first grip and a second grip is secured on the bottom end portions of the first elongated member and the second elongated member, respectively, for enabling a user to properly grip the snow ball making apparatus.

These together with the other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a snow ball forming apparatus, in accordance with an exemplary embodiment of the present invention; and

FIG. 2 illustrates a top view of a top end portion of a first elongated member of the snow ball forming apparatus of FIG. 1.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a snow ball forming apparatus. The snow ball forming apparatus assists a person to form snow balls easily without getting his/her hands wet and frozen. Moreover, the snow ball forming apparatus is easy to handle and capable of assisting the person in forming a snow ball of a suitable size, which may be easily held by the person.

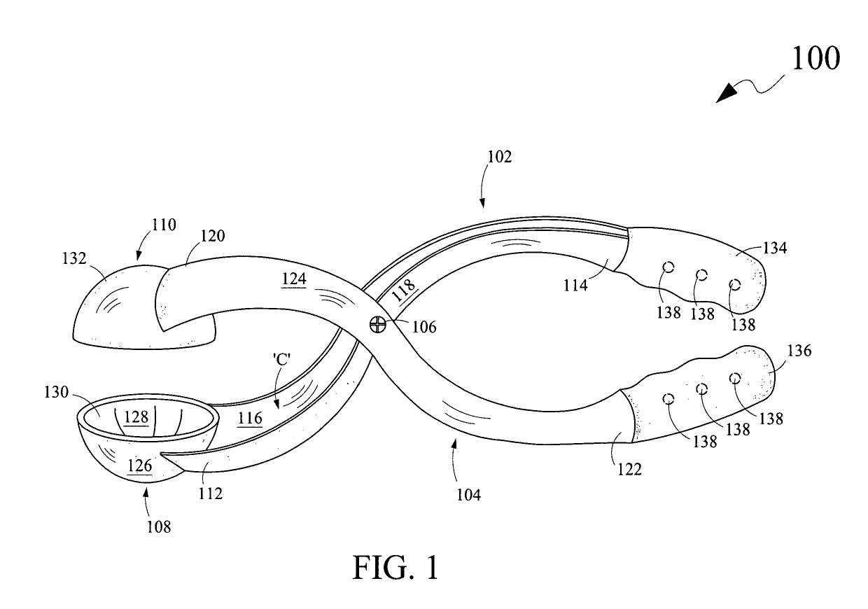

Referring to FIG. 1, a snow ball forming apparatus 100 for forming snow balls is shown. More specifically, FIG. 1 illustrates a perspective view of the snow ball forming apparatus 100, in accordance with an embodiment of the present invention. The snow ball forming apparatus 100 includes a first elongated member 102, a second elongated member 104, an attachment means 106, a first hemispherical cup 108 and a second hemispherical cup 110. The first elongated member 102 includes a top end portion 112, a bottom end portion 114, an inner surface 116 and an outer surface 118. More specifically, the inner surface 116 and the outer surface 118 extends between the top end portion 112 and the bottom end portion 114 to configure a channel ‘C’ extending between the top end portion 112 and the bottom end portion 114 of the first elongated member 102. In an embodiment of the present invention, the channel ‘C’ may have a U-shaped cross-section, as illustrated in FIG. 1. However, it will be apparent to a person skilled in the art that the channel ‘C’ may have cross-sections of any other shape, such as a V-shaped cross-section.

The second elongated member 104 is similar to first elongated member 102. More specifically, the second elongated member 104 includes a top end portion 120, a bottom end portion 122, an inner surface (not shown) and an outer surface 124. The inner surface and the outer surface 124 configure a channel (not shown), similar to channel ‘C’ of the first elongated member 102, extending between the top end portion 120 and the bottom end portion 122. Accordingly, on account of the second elongated member 104 being structurally similar to the first elongated member 102, an explanation thereof has been omitted.

The first elongated member 102 and the second elongated member 104 may be composed of a metallic material such as steel, aluminum, and the like. However, it will be apparent to a person skilled in the art that any other material that provides sufficient structural integrity may also be utilized for forming the first elongated member 102 and the second elongated member 104.

Moreover, the first elongated member 102 has the first hemispherical cup 108 configured at the top end portion 112 thereof. More specifically, the first hemispherical cup 108 may be coupled to the top end portion 112 of the first elongated member 102. The first hemispherical cup 108 includes an outer surface 126 and an inner surface 128. The outer surface 126 and the inner surface 128 configure a first cavity 130. In use, the first cavity 130 is adapted to receive snow for enabling the snow ball forming apparatus 100 to form a snow ball. In an embodiment of the present invention, the first hemispherical cup 108 may be composed of a metallic material, such as steel, aluminum, and the like. However, it will be apparent to a person skilled in the art that the first hemispherical cup 108 may be composed of any other materials known in the art that provides sufficient structural integrity to the first hemispherical cup 108.

Moreover, the first hemispherical cup 108 may be coated with a rubber material (hereinafter referred to as ‘the rubber coating’). More specifically, the rubber coating may be formed on the outer surface 126 and the inner surface 128 of the first hemispherical cup 108 to preclude the snow contained within the first cavity 130 from sticking on to the inner surface 128. In an embodiment of the present invention, the rubber coating may be formed on the first hemispherical cup 108 by dipping the first hemispherical cup 108 in a liquidized rubber material and subsequently cooling the first hemispherical cup 108 to form the rubber coating thereon.

Similarly, the second hemispherical cup 110 may be configured at the top end portion 120 of the second elongated member 104. More specifically, the second hemispherical cup 110 may be coupled to the top end portion 120 of the second elongated member 104. The second hemispherical cup 110 is structurally similar to the first hemispherical cup 108. More particularly, the second hemispherical cup 110 includes an outer surface 132, an inner surface (not shown) and a cavity (not shown) similar to the corresponding components of the first hemispherical cup 108. Moreover, the second hemispherical cup 110 is coated with a rubber coating similar to the rubber coating on the first hemispherical cup 108.

Without limiting the scope of the present invention, the first hemispherical cup 108 may be welded to the top end portion 112 of the first elongated member 102 using a welding method, such as an arc welding, a laser beam welding, an electron beam welding or any other types of welding methods known in the art. Similarly, the second hemispherical cup 110 may be welded to the top end portion 120 of the second elongated member 104 by using any of the welding methods described herein. However, it will be evident to a person skilled in the art that any other conventional coupling method may also be utilized for configuring the first hemispherical cup 108 and the second hemispherical cup 110 on the first elongated member 102 and the second elongated member 104, respectively.

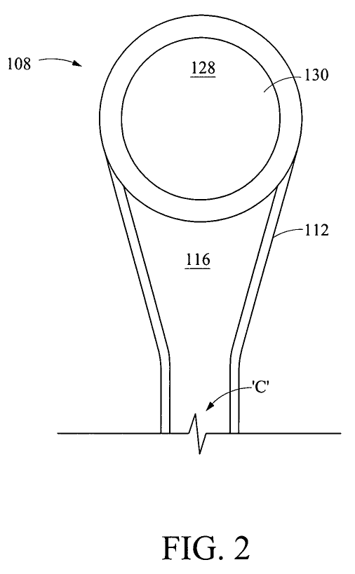

Furthermore, in an embodiment of the present invention, the top end portion 112 may be flared to enable a firm coupling between the first hemispherical cup 108 and the top end portion 112 of the first elongated member 102. The flared top end portion 112 will be explained in detail in conjunction with FIG. 2. Similarly, the top end portion 120 of the second elongated member 104 may be flared to enable a firm coupling between the second hemispherical cup 110 and the top end portion 120 of the second elongated member 104.

Moreover, the first elongated member 102 and the second elongated member 104 are hingedly coupled to each other with the help of the attachment means 106, as shown in FIG. 1. More specifically, the first elongated member 102 and the second elongated member 104 are adapted to hingedly move about the attachment means 106 to assume at least one of a closed position and an open position of the snow ball forming apparatus 100. For assuming the closed position of the snow ball forming apparatus 100, the first hemispherical cup 108 and the second hemispherical cup 110 are adapted to move towards each other. More particularly, the first cavity 130 of the first hemispherical cup 108 and the second cavity of the second hemispherical cup 110 move towards each other. Alternatively, the first hemispherical cup 108 and the second hemispherical cup 110 are adapted to move away from each other to assume the open position of the snow ball forming apparatus 100.

Moreover, the first elongated member 102 and the second elongated member 104 are configured in a manner, such that upon assuming the closed position, the first hemispherical cup 108 is aligned with the second hemispherical cup 110. More specifically, in the closed position the first cavity 130 of the first hemispherical cup 108 and the second cavity of the second hemispherical cup 110 may be facing each other. In an embodiment of the present invention, the alignment between the first hemispherical cup 108 and the second hemispherical cup 110 may be achieved by laterally bending both of the first elongated member 102 and the second elongated member 104 towards each other. In another embodiment of the present invention, the alignment between the first hemispherical cup 108 and the second hemispherical cup 110 may be achieved by laterally bending either of the first elongated member 102 and the second elongated member 104.

Accordingly, the attachment means 106 enables the first hemispherical cup 108 and the second hemispherical cup 110 to be hingedly moved towards or away from each other. In an embodiment of the present invention, the attachment means 106 may include a pin. The pin may be inserted through the first elongated member 102 and the second elongated member 104 and thereafter the pin may be flattened at both ends for configuring a firm coupling therebetween. In an embodiment of the present invention, the attachment means 106 may be composed of a metallic material, such as steel, aluminum, or any other material that provides sufficient structural integrity to the attachment means. Further, it will be apparent to a person skilled in the art that the first elongated member 102 and the second elongated member 104 may also be hingedly coupled to each other by using other coupling arrangements known in the art.

The snow ball forming apparatus 100 may further include a first grip 134 and a second grip 136. The first grip 134 may be secured at the bottom end portion 114 of the first elongated member 102. Similarly, the second grip 136 may be configured at the bottom end portion 122 of the second elongated member 104. The first grip 134 and the second grip 136 (hereinafter collectively referred to as “grip”) may be preferably composed of a rubber material.

In an embodiment of the present invention, the grip may be secured to the first elongated member 102 and the second elongated member 104 by coating the bottom end portion 114 and the bottom end portion 122 thereof, respectively, with a rubber material. More specifically, the bottom end portion 114 of the first elongated member 102 may be flared and thereafter a plurality of holes may be configured therein. For example, as shown in FIG. 1, three holes 138 are configured in the bottom end portion 114 of the first elongated member 102. It will be evident to a person skilled in the art that any number of holes may be configured in the bottom end portion 114. Similarly, the bottom end portion 122 of the second elongated member 104 may be flared and thereafter a plurality of holes may be configured therein.

Subsequently, the bottom end portion 114 and 122 may be dipped in a liquidized rubber material, which forms a coating on the bottom end portions 114 and 122 upon cooling. The holes 138 enable the rubber material to firmly adhere to the bottom end portions 114 and 122, thereby securing the grip thereto. As a result, the grip may be prevented from sliding off from the bottom end portions 114 and 122 upon frequent handling by a user of the snow ball forming apparatus 100.

Referring now to FIG. 2, a top view of the top end portion 112 of the first elongated member 102 is illustrated. More specifically, as shown in the FIG. 2, the first elongated member 102 may be flared at the top end portion 112. Accordingly, the channel ‘C’ formed in the first elongated member 102 is flared at the top end portion 112. In an embodiment of the present invention, the channel ‘C’ may be flared to have a “V-shaped” cross-section. It will be, however, apparent to a person skilled in the art that the channel ‘C’ may be flared to have a cross-section of any other shapes, such as a “U-Shape”.

Moreover, the top end portion 120 of the second elongated member 104 may be flared for coupling the second hemispherical cup 110 thereto. The flaring of the top end portions 112 and 120 is advantageous since it enables formation of a strengthened coupling between the respective top end portions, such as the top end portion 112 and the top end portion 120, and the hemispherical cups, such as the first hemispherical cup 108 and the second hemispherical cup 110, of the snowball forming apparatus 100. Moreover, the flaring of the top end portions 112 and 120 also enables alignment of the first hemispherical cup 108 and the second hemispherical cup 110 in the closed position of the snow ball forming apparatus 100.

In use, the snow ball forming apparatus 100 may be brought in the open position thereof by a user. Thereafter, the first hemispherical cup 108 and the second hemispherical cup 110 may be dipped in snow such that the first cavity 130 of the first hemispherical cup 108 and the second cavity of the second hemispherical cup 110 receive the snow therein. Subsequently, the user may hingedly move the first elongated member 102 and the second elongated member 104 towards each other to assume the closed position of the snow ball forming apparatus 100. Upon assuming the closed position, the snow contained in the first cavity 130 and the second cavity is pressed against each other thereby adhering to form a spherical snow ball. Thereafter, the user may enable the open position of the snow ball forming apparatus 100 to release the formed snow ball. The formed snow ball may be used by the user for throwing to or at other people for playing a snow ball game.

The snow ball forming apparatus, as described herein, may be provided in a variety of colors thereby imparting an aesthetic look thereto. In an exemplary embodiment of the present invention, the snow ball forming apparatus, such as the snow ball forming apparatus 100, may have a length of about 15 inches and a width span of about 6 inches. In another exemplary embodiment of the present invention, the channel, such as channel ‘C’, formed in the elongated members, such as the first elongated member 102 and the second elongated member 104, may have a wall thickness varying from about three-fourth of an inch to about 1 inch. In yet another embodiment of the present invention, the snow ball forming apparatus may be packed in form of a package. It will be apparent to a person skilled in the art that one or more snow ball forming apparatuses, such as the snow ball forming apparatus 100 may be packed in the package and provided to the user.

The snow ball forming apparatus, explained in conjunction with FIGS. 1 and 2, may be advantageously used by a user for forming snow balls easily and conveniently. Moreover, the snow ball forming apparatus is durable and has more strength since it is composed of a metallic material. Further, rubber coating on the hemispherical cups of the snow ball forming apparatus prevents the snow received in the hemispherical cups from sticking to the inner surface thereof, thereby avoiding caking of the snow. In addition, the elongated members of the snow ball forming apparatus include a channel configured therein. The channel prevents a bending of the attachment means, such as a pin, used for coupling the elongated members while the elongated members are being hingedly moved. Accordingly, the channel prevents misalignment of the hemispherical cups configured on the elongated members. Additionally, the grips secured to the elongated members enable a user to firmly grip the snow ball forming apparatus for forming a snow ball conveniently

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

1. A snow ball forming apparatus, comprising:
a first elongated member having a top end portion, a bottom end portion, and an inner surface and an outer surface extending between the top end portion and the bottom end portion of the first elongated member wherein the first elongated member is flared at the top end portion;
a second elongated member having a top end portion, a bottom end portion and an inner surface and an outer surface extending between the top end portion and the bottom end portion of the second elongated member, wherein the second elongated member is flared at the top end portion;
an attachment means for hingedly coupling the second elongated member with the first elongated member at a substantially central portion of the first elongated member and the second elongated member; and
a first hemispherical cup configured at the top end portion of the first elongated member and a second hemispherical cup configured at the top end portion of the second elongated member, wherein each of the first hemispherical cup and the second hemispherical cup comprise a cavity configured therein, the cavity being adapted to receive snow, and wherein the each of the first hemispherical cup and the second hemispherical cup is coated with a rubber material;
wherein upon hingedly moving the first elongated member and the second elongated member about the attachment means, the snow ball forming apparatus is capable of assuming at least one of a closed position and an open position, and
wherein to assume the closed position of the snow ball forming apparatus, the first hemispherical cup and the second hemispherical cup move towards each other, and
wherein in the closed position, a snow ball is formed from the snow received in the cavity of the each of the first hemispherical cup and the second hemispherical cup.

2. The snow ball forming apparatus of claim 1, wherein the first elongated member and the second elongated member are composed of a metallic material.

3. The snow ball forming apparatus of claim 1, wherein the first hemispherical cup and the second hemispherical cup are composed of a metallic material.

4. The snow ball forming apparatus of claim 1, wherein the inner surface and the outer surface of the first elongated member configures a channel between the top end portion and the bottom end portion of the first elongated member.

5. The snow ball forming apparatus of claim 4, wherein the channel has a U-shaped cross-section.

6. (canceled)

7. The snow ball forming apparatus of claim 1, wherein the first elongated member is flared at the bottom end portion.

8. The snow ball forming apparatus of claim 1, wherein the inner surface and the outer surface of the second elongated member configures a channel between the top end portion and the bottom end portion of the second elongated member.

9. The snow ball forming apparatus of claim 8, wherein the channel has a U-shaped cross-section.

10. (canceled)

11. The snow ball forming apparatus of claim 1, wherein the second elongated member is flared at the bottom end portion.

12. The snow ball forming apparatus of claim 1, wherein the attachment means is a pin.

13. The snow ball forming apparatus of claim 1 further comprising a first grip, the first grip secured at the bottom end portion of the first elongated member.

14. The snow ball forming apparatus of claim 13, wherein the first elongated member further comprises a plurality of holes configured at the bottom end portion of the first elongated member, the plurality of holes enabling the first grip to be secured to the bottom end portion of the first elongated member.

15. The snow ball forming apparatus of claim 13, wherein the first grip is composed of a rubber material.

16. The snow ball forming apparatus of claim 1 further comprising a second grip, the second grip secured at the bottom end portion of the second elongated member.

17. The snow ball forming apparatus of claim 16, wherein the second elongated member further comprises a plurality of holes configured at the bottom end portion of the second elongated member, the plurality of holes enabling the second grip to be secured to the bottom end portion of the second elongated member.

18. The snow ball forming apparatus of claim 16, wherein the second grip is composed of a rubber material.
